(19) United States
(12) Patent Application Publication
(10) Pub. No.: US 2021/0345617 A1
(43) Pub. Date: Nov. 11, 2021

(54) NANOSTRUCTURED PRODUCT FOR FACILITATING DEACTIVATING OF MICROORGANISMS

(71) Applicant: John Arthur Disegi, Reading, PA (US)

(72) Inventor: John Arthur Disegi, Reading, PA (US)

(21) Appl. No.: 17/317,705

(22) Filed: May 11, 2021

Related U.S. Application Data
(60) Provisional application No. 63/023,129, filed on May 11, 2020.

(51) Int. Cl. A01N 59/20; A01N 25/08; A01N 25/34

(52) U.S. Cl. CPC A01N 59/20; A01N 25/34; A01N 25/08

(57) ABSTRACT

Disclosed herein is a nanostructured product for facilitating deactivating of microorganisms, in accordance with some embodiments. Accordingly, the nanostructured product comprises a substrate may include a layer. Further, the layer is comprised of at least one of a pure metal of a metal, a metal oxide of the metal, and a metal alloy of the metal. Further, the metal comprises copper. Further, the layer comprises a nanostructured surface. Further, the nanostructured surface is configured for deactivating a microorganism physically contacting the nanostructured surface. Further, the nanostructured surface comprises nanostructured copper protrusions extending away from the nanostructured surface. Further, the nanostructured copper protrusions are configured for physically penetrating a cellular structure of the microorganism coming in a physical contact with the nanostructured surface of the layer of the substrate. Further, the deactivating of the microorganism is based on the physically penetrating of the cellular structure of the microorganism.

The current application claims a priority to the U.S. Provisional Patent application Ser. No. 63/023,129 filed on May 11, 2020.

### FIELD OF THE INVENTION

Generally, the present disclosure relates to the field of nanotechnology. More specifically, the present disclosure relates to a nanostructured product for facilitating deactivating of microorganisms.

### BACKGROUND OF THE INVENTION

Copper tends to form a copper oxide surface when exposed to the atmosphere. A copper or copper oxide surface is known to display antimicrobial and antiviral properties [1]. Recently documented information [2] indicates that severe acute respiratory syndrome coronavirus 2 (SARS-CoV-2) displayed the shortest half-life retention on copper when compared to stainless steel, cardboard, and plastic. Information from the Copper Development Association [3] also indicates that research is being conducted to evaluate the antimicrobial properties of copper nanoparticles.

A nanostructured stainless-steel surface [4] has demonstrated microbial deactivation of gram-negative E. coli and gram-positive S. aureus. Nanostructured spikes on stainless steel only disrupted bacterial cell walls because mammalian cells are larger than microbes. Pulse anodizing a titanium implant surface has provided a nanostructured implant surface [5] that deactivated a variety of clinically relevant pathogens such as Methicillin Resistant Staphlococcus Aureus (MRSA) and Streptococcus sanguinis (S. sanguinis).

Existing products for facilitating deactivating of microorganisms are deficient with regard to several aspects. For instance, current products do not effectively deactivate the microorganism coming in contact with the products. Furthermore, current products do not include a metal that effectively deactivates the microorganism coming in contact with the products.

Therefore, there is a need for a nanostructured product for facilitating deactivating of microorganisms that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a nanostructured product for facilitating deactivating of microorganisms, in accordance with some embodiments. Accordingly, the nanostructured product may include a substrate may include at least one layer. Further, the at least one layer may be comprised of at least one of a pure metal of at least one metal, a metal oxide of the at least one metal, and a metal alloy of the at least one metal. Further, the at least one metal may include copper. Further, the at least one layer may include at least one nanostructured surface. Further, the at least one nanostructured surface may be configured for deactivating at least one microorganism physically contacting the at least one nanostructured surface. Further, the at least one nanostructured surface may include nanostructured copper protrusions extending away from the at least one nanostructured surface. Further, the nanostructured copper protrusions may be configured for physically penetrating a cellular structure of the at least one microorganism coming in a physical contact with the at least one nanostructured surface of the at least one layer of the substrate of the nanostructured product. Further, the deactivating of the at least one microorganism may be based on the physically penetrating of the cellular structure of the at least one microorganism.

Further disclosed herein is a nanostructured product for facilitating deactivating of microorganisms, in accordance with some embodiments. Accordingly, the nanostructured product may include a substrate may include at least one layer. Further, the at least one layer may be comprised of at least one of a pure metal of at least one metal, a metal oxide of the at least one metal, and a metal alloy of the at least one metal. Further, the at least one metal may include copper. Further, the at least one layer may include at least one nanostructured surface. Further, the at least one nanostructured surface may be configured for deactivating at least one microorganism physically contacting the at least one nanostructured surface. Further, the at least one nanostructured surface may include nanostructured copper protrusions extending away from the at least one nanostructured surface. Further, the nanostructured copper protrusions may be configured for physically penetrating a cellular structure of the at least one microorganism coming in a physical contact with the at least one nanostructured surface of the at least one layer of the substrate of the nanostructured product. Further, the deactivating of the at least one microorganism may be based on the physically penetrating of the cellular structure of the at least one microorganism. Further, the at least one layer may include at least one pore of at least one size. Further, the at least one pore allows entering of the at least one microorganism coming in the physical contact with the at least one nanostructured surface of the at least one layer of the substrate for trapping the at least one microorganism in the at least one pore. Further, the deactivating of the at least one microorganism may be based on the trapping of the at least one microorganism in the at least one pore.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a nanostructured surface of a nanostructured product for facilitating deactivating of microorganisms, in accordance with some embodiments.

FIG. 2 illustrates a porous nanostructured surface of the nanostructured product, in accordance with some embodiments.

FIG. 3 is a table of relative sizes of structures associated with the nanostructure product, in accordance with some embodiments.

FIG. 4 is a table of results obtained by performing surface analysis of the nanostructure product, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a nanostructured product for facilitating deactivating of microorganisms, embodiments of the present disclosure are not limited to use only in this context.

Overview:

The present disclosure describes a nanostructured product for facilitating deactivating of microorganisms. Further, the present disclosure relates generally to copper surfaces. More specifically, the present disclosure describes the porous nanostructured copper for microbial and viral deactivation.

Further, the present disclosure describes the presence of porous nanostructured bulk copper, the presence of a porous nanostructured copper film, or the presence of a porous nanostructured copper coating to provide microbial and viral deactivation. The reaction mechanism is not universally understood but mechanical disruption of a cell wall or membrane represents a common feature that may explain the bacterial and viral response to a porous nanostructured surface.

Further, the present disclosure describes a presence of porous nanostructured bulk copper, the presence of a porous nanostructured copper film, or the presence of a porous nanostructured copper coating to provide increased microbial and viral deactivation. Nanostructured bulk copper refers to pure copper, copper oxide, or copper alloys with a copper surface and a copper substrate that is produced by various melting, powder metallurgy (PM) consolidation, chemical decomposition, thermal de-alloying, inert gas foaming, 3D printing, or other well-known methods of production. A nanostructured pure copper, copper oxide, or copper alloy film or coating may be created by magnetron sputtering, physical vapor deposition (PVD), chemical vapor deposition (CVD), chemical plating, ion plating, metallurgical cladding, metal powder sintering, and other well-known methods for producing a copper surface on a metallic or nonmetallic substrate. The nanostructured bulk copper, nanostructured copper film, or nanostructured copper coating may exhibit surface porosity or may be subjected to acid pickling, chemical etching, plasma etching, ion etching, media blasting, thermal treatment, chemical de-alloying, or other well-known methods for providing a porous surface. An advantage of the nanostructured product is related to the antimicrobial and antiviral destruction mechanism that relies on physical contact rather than biochemical reactions that can pose drug resistance issues. Human cells are approximately one order of magnitude (10×) and approximately two orders of magnitude (100×) larger than bacterial and viral structures, respectively. This observation accounts for the fact that the microbial or viral destruction mechanism does not disrupt mammalian cells. Reduced pathogenic transmission from hand contact to an internal human entry site such as an open wound, a mouth, a nose, and eyes is a positive feature. The capability to reduce microbial and viral transmission on touch surfaces, for example, in hospitals, health care facilities, public spaces, airports, sports stadiums, cruise ships, military bases, mass transit systems, shopping centers, office buildings, entertainment facilities, hotels, food processing plants, and the home environment.

Further, the nanostructured product has antiviral applications. Further, the antiviral applications may include face masks and coverings composed of porous nanostructured copper or copper alloys. Face masks, filters, and coverings fabricated from paper, polymer, fabric, or composite materials may also include porous nanostructured copper inserts, powder, or filaments that provide viral deactivation. The copper containing face masks, filters, and coverings function by trapping and deactivating viral particles before they can be inhaled. Superficial protrusions associated with the porous nanostructured surface are smaller than the virus in order to provide physical penetration of the cellular structure. It is postulated that the viral destruction mechanism relies on nanostructured copper protrusions that penetrate cellular structures and produce pathogenic death.

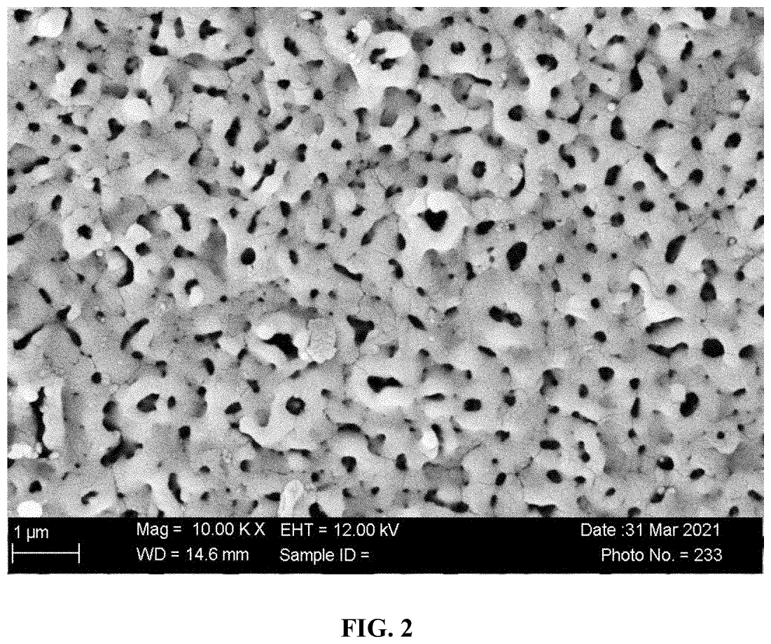

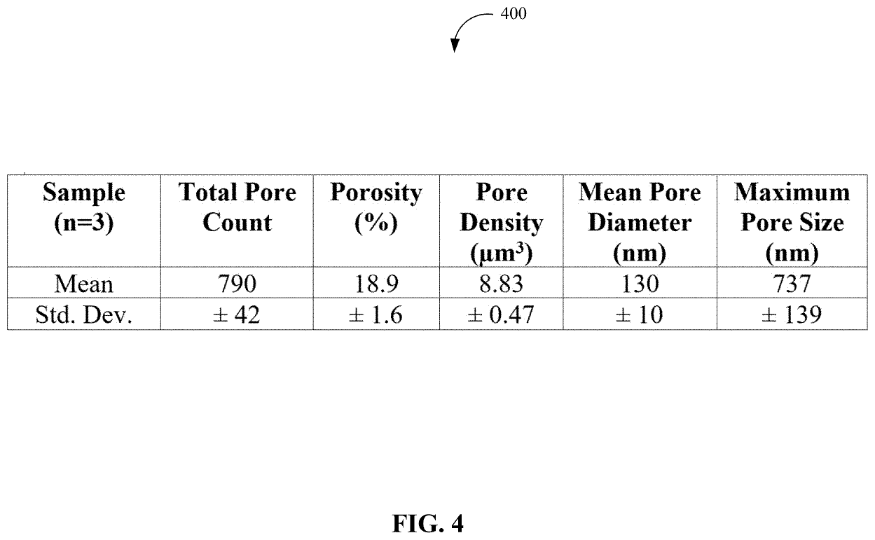

Further, the deactivating of microorganisms using the nanostructured product is demonstrated using examples. For example 1, specimens were prepared from a 99.95% copper bar and processed to provide a porous nanostructured copper surface. Topographical features were measured by Zeiss Supra 40 scanning electron microscopy (SEM), Clemex image analysis, and atomic force microscopy (AFM). A porous nanostructured copper surface is shown in FIG. 2. Surface analysis included total pore count, porosity, pore density, mean pore diameter, and maximum pore size. Number of samples, mean values, and standard deviation (Std. Dev.) results are shown in FIG. 4.

For Example 1, MRSA bacteria were cultured on trypticase soy agar (TSA) and incubated for 18 hours at 37° C. Isolated colonies were inoculated in tryptic soy broth (TSB), grown with aeration at 37° C. for an additional 18 hours, and the late phase culture of 108 CFU/ml was confirmed through optical density testing at 600 nm wavelength. Porous nanostructured coupons were sterilized, placed into sterilized 50 ml centrifuge tubes, and 40 ml TSB plus 40 ml MRSA were added to the tubes. The positive control consisted of a sterilized 50 ml centrifuge tube filled with 40 ml of TSB and 40 μl of MRSA. The MRSA inoculated coupons were incubated under aeration for 24 hours. After 24 hours, a vacuum pipette removed the bacteria from the coupons, and the coupons were placed in a new sterilized 50 ml centrifuge tube filled with 40 ml of phosphate buffered saline (PBS), and the attached bacteria were collected by vibration on a vibratory shaker for 30 seconds. Bacteria were subcultured overnight at 37° C. on TSB agar plates at 100-fold dilution with PBS. The positive control bacteria were also serial diluted 100-fold and cultured on TSB agar plates at 37° C. for 24 hours. This sequence provided an initial inoculum concentration of 10⁵ CFU/ml bacterial load on the specimens. The plates were removed from the oven after 24 hours and the viable individual colonies were counted. After 24 hours of incubation, the MRSA positive control group had an average bacteria count of 2.1×10⁷ CFU/ml while the porous nanostructured copper surface had an average bacteria count of 7.3×10⁵ CFU/ml. Greater than 20 million MRSA bacteria were deactivated which was significant because MRSA represents one of the most difficult pathogens to manage with antibacterial drugs.

For, example 2, porous nanostructured copper test specimens were prepared and processed in an identical manner as described in example 1 except the pathogenic exposure consisted of colonies of S. sanguinis bacteria. After 24 hours of inoculation, the S. sangunis positive control group had an average bacterial count of 3.5×10⁷ CFU/ml while the porous nanostructured copper surface had an average bacteria count of 3.2×10³ CFU/ml.

Results represent four orders of magnitude reduction in average bacteria count which is the benchmark that is utilized for regulatory scrutiny of antimicrobial effectiveness.

Further, the present disclosure describes a nanostructured product including a porous nanostructured bulk copper, porous nanostructured thin copper film, or porous nanostructured thick copper coating that provides microbial and viral deactivation. Further, the nanostructured product has a capability to decrease microbial and viral transmission on touch surfaces. Further, the nanostructured product has the ability to construct face masks, filters, and coverings that offer increased protection against human microbial and viral transmission.

Further, the present disclosure relates generally to copper surfaces. More specifically, the present disclosure covers the presence of porous nanostructured bulk copper or the presence of a porous nanostructured film or coating on metallic and nonmetallic substrates to provide increased microbial and viral deactivation.

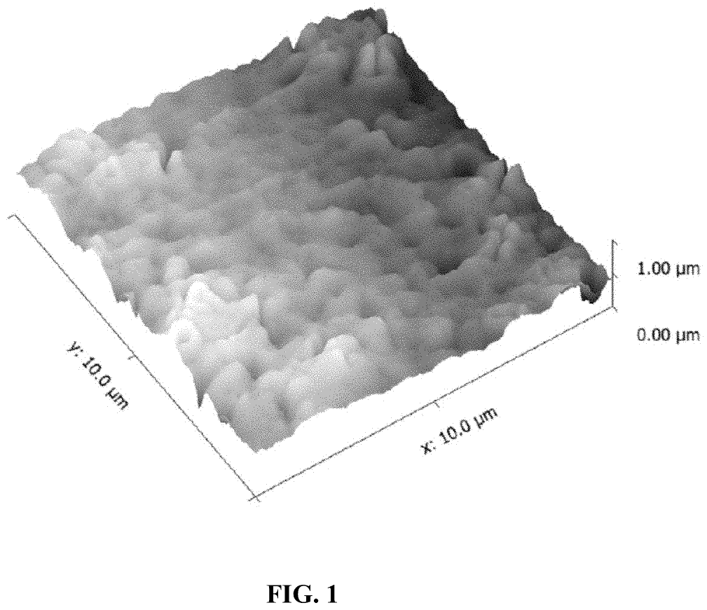

FIG. 1 illustrates a nanostructured surface of a nanostructured product for facilitating deactivating of microorganisms, in accordance with some embodiments. Further, the nanostructured product may include a substrate may include at least one layer. Further, the at least one layer may be comprised of at least one of a pure metal of at least one metal, a metal oxide of the at least one metal, and a metal alloy of the at least one metal. Further, the at least one metal may include copper. Further, the at least one layer may include at least one nanostructured surface. Further, the at least one nanostructured surface may be configured for deactivating at least one microorganism physically contacting the at least one nanostructured surface. Further, the at least one microorganism may include bacteria, viruses, protozoa, fungi, etc. Further, the at least one microorganism may be a disease-causing pathogen. Further, the at least one nanostructured surface may include nanostructured copper protrusions extending away from the at least one nanostructured surface. Further, the nanostructured copper protrusions may be configured for physically penetrating a cellular structure of the at least one microorganism coming in a physical contact with the at least one nanostructured surface of the at least one layer of the substrate of the nanostructured product.

Further, the cellular structure may include a cell wall, a cell membrane, a capsid, etc. Further, the deactivating of the at least one microorganism may be based on the physically penetrating of the cellular structure of the at least one microorganism.

Further, in some embodiments, the at least one layer may include at least one pore of at least one size. Further, the at least one pore allows entering of the at least one microorganism coming in the physical contact with the at least one nanostructured surface of the at least one layer of the substrate for trapping the at least one microorganism in the at least one pore. Further, the deactivating of the at least one microorganism may be based on the trapping of the at least one microorganism in the at least one pore.

Further, in an embodiment, the trapping of the at least one microorganism prevents subsequent physical contacting between the at least one microorganism and at least one object coming in a physical contact with the at least one nanostructured surface for preventing transferring of the at least one microorganism to the at least one object.

Further, in an embodiment, the at least one pore may be created in the at least one layer using at least one pore creating process. Further, the at least one pore creating process may be applied to the at least one layer for creating the at least one pore of the at least one size. Further, the at least one layer may include the at least one pore based on the creating of the at least one pore.

Further, in some embodiments, the deactivating of the at least one microorganism prevents transmitting of the at least one microorganism from the at least one nanostructured surface to at least one object coming in a physical contact with the at least one nanostructured surface.

Further, in some embodiments, the nanostructured copper protrusions may be associated with a protrusion size. Further, the protrusion size of the nanostructured copper protrusions may be smaller than a microorganism size of the at least one microorganism. Further, the physically penetrating of the cellular structure of the at least one microorganism may be based on the protrusion size.

Further, in some embodiments, the substrate may be comprised of at least one substrate metal. Further, the at least one substrate metal may be similar to the at least one metal. Further, the at least one substrate metal may be copper.

Further, in some embodiments, the substrate may be comprised of at least one substrate metal. Further, the at least one substrate metal may not be similar to the at least one metal.

Further, in some embodiments, the substrate may be comprised of at least one substrate non-metal.

Further, in some embodiments, the at least one layer may be created on the substrate using at least one layer creating process. Further, the at least one layer creating process may be applied on the substrate for creating the at least one layer on the substrate. Further, the substrate may include the at least one layer based on the creating.

Further, in an embodiment, the creating of the at least one layer on the substrate produces the nanostructured copper protrusions on at least one nanostructured surface in at least one protrusion arrangement. Further, the at least one protrusion arrangement may include a radial arrangement, a polygonal arrangement, a linear arrangement, a random arrangement, etc. Further, the at least one nanostructured surface may include the nanostructured copper protrusions based on the creating of the at least one layer. Further, in an embodiment, the at least one nanostructured surface may be associated with a deactivating ability for the deactivating of the at least one microorganism. Further, the deactivating ability may be based on the at least one protrusion arrangement of the nanostructured copper protrusion.

Further, in some embodiments, the at least one microorganism comes in the physical contact with the at least one layer of the substrate of the nanostructured product using at least one microorganism carrier. Further, the at least one microorganism carrier may include an animate object, an inanimate object, etc. Further, the inanimate object may include water, air, etc. that may carry the at least one microorganism. Further, the animate object may include a human, animal, insect, etc. that may carry the at least one microorganism. Further, the at least one microorganism carrier performs at least one contacting action on the nanostructured product. Further, the at least one contacting action may include touching, rubbing, passing, etc. Further, the at least one microorganism comes in the physical contact with the at least one layer of the substrate of the nanostructured product based on the at least one contacting action performed on the nanostructured product.

FIG. 2 illustrates a porous nanostructured surface of the nanostructured product, in accordance with some embodiments.

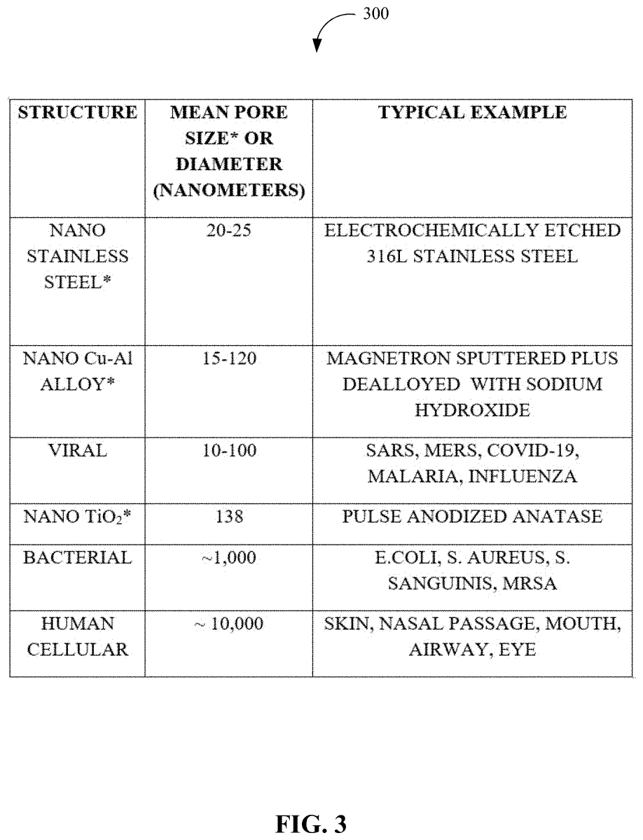

FIG. 3 is a table 300 of relative sizes of structures associated with the nanostructure product, in accordance with some embodiments.

FIG. 4 is a table 400 of results obtained by performing surface analysis of the nanostructure product, in accordance with some embodiments.

Further disclosed herein, is a nanostructured surface of a nanostructured product for facilitating deactivating of microorganisms, in accordance with some other embodiments. Further, the nanostructured product may include a substrate may include at least one layer. Further, the at least one layer may be comprised of at least one of a pure metal of at least one metal, a metal oxide of the at least one metal, and a metal alloy of the at least one metal. Further, the at least one metal may include copper. Further, the at least one layer may include at least one nanostructured surface. Further, the at least one nanostructured surface may be configured for deactivating at least one microorganism physically contacting the at least one nanostructured surface. Further, the at least one nanostructured surface may include nanostructured copper protrusions extending away from the at least one nanostructured surface. Further, the nanostructured copper protrusions may be configured for physically penetrating a cellular structure of the at least one microorganism coming in a physical contact with the at least one nanostructured surface of the at least one layer of the substrate of the nanostructured product. Further, the deactivating of the at least one microorganism may be based on the physically penetrating of the cellular structure of the at least one microorganism. Further, the at least one layer may include at least one pore of at least one size. Further, the at least one pore allows entering of the at least one microorganism coming in the physical contact with the at least one nanostructured surface of the at least one layer of the substrate for trapping the at least one microorganism in the at least one pore. Further, the deactivating of the at least one microorganism may be based on the trapping of the at least one microorganism in the at least one pore.

Further, in some embodiments, the trapping of the at least one microorganism prevents subsequent physical contacting between the at least one microorganism and at least one object coming in a physical contact with the at least one nanostructured surface for preventing transferring of the at least one microorganism to the at least one object.

Further, in some embodiments, the at least one pore may be created in the at least one layer using at least one pore creating process. Further, the at least one pore creating process may be applied to the at least one layer for creating the at least one pore of the at least one size. Further, the at least one layer may include the at least one pore based on the creating of the at least one pore.

Further, in some embodiments, the deactivating of the at least one microorganism prevents transmitting of the at least one microorganism from the at least one nanostructured surface to at least one object coming in a physical contact with the at least one nanostructured surface.

Further, in some embodiments, the nanostructured copper protrusions may be associated with a protrusion size. Further, the protrusion size of the nanostructured copper protrusions may be smaller than a microorganism size of the at least one microorganism. Further, the physically penetrating of the cellular structure of the at least one microorganism may be based on the protrusion size.

Further, in some embodiments, the at least one layer may be created on the substrate using at least one layer creating process. Further, the at least one layer creating process may be applied on the substrate for creating the at least one layer on the substrate. Further, the substrate may include the at least one layer based on the creating

Further, in some embodiments, the at least one microorganism comes in the physical contact with the at least one layer of the substrate of the nanostructured product using at least one microorganism carrier. Further, the at least one microorganism carrier performs at least one contacting action on the nanostructured product. Further, the at least one microorganism comes in the physical contact with the at least one layer of the substrate of the nanostructured product based on the at least one contacting action performed on the nanostructured product.

Although the present disclosure has been explained in relation to its preferred embodiment, it is to be understood that many other possible modifications and variations can be made without departing from the spirit and scope of the disclosure.

### REFERENCES

[1] Michels H T and Michels C A, Can Copper Help Fight Covid-19?, Advanced Materials & Processes e News, Digital First, Apr. 29, 2020.

[2] van Doremalen, N., et al, Aerosol and Surface Stability of SARS-CoV-2 as Compared with SARS-CoV-1, The New England Journal of Medicine, downloaded from nejm.org on Mar. 26, 2020.

[3] Dresher W H, Copper Applications in Innovative Technology Area, Copper Development Association Inc, Internet article, January 2006.

[4] Jang, Y., et al, Inhibition of Bacterial Adhesion on Nanotextured Stainless Steel 316L by Electrochemical Etching, ACS Biomaterials Science & Engineering, Vol 4, No.1, 2018, pp. 90-97.

[5] Williamson, R S, Disegi, J A., Marquart M, and Roach, M., Antimicrobial Properties of Anodized Titanium Components Used in a Combination Device, in Antimicrobial Combination Devices, ASTM STP 1630, K Urish and B Mihalko, Eds., ASTM International, West Conshohocken, Pa., 19428, accepted for publication Mar. 9, 2020.

What is claimed is:

1. A nanostructured product for facilitating deactivating of microorganisms, wherein the nanostructured product comprises a substrate comprising at least one layer, wherein the at least one layer is comprised of at least one of a pure metal of at least one metal, a metal oxide of the at least one metal, and a metal alloy of the at least one metal, wherein the at least one metal comprises copper, wherein the at least one layer comprises at least one nanostructured surface, wherein the at least one nanostructured surface is configured for deactivating at least one microorganism physically contacting the at least one nanostructured surface, wherein the at least one nanostructured surface comprises nanostructured copper protrusions extending away from the at least one nanostructured surface, wherein the nanostructured copper protrusions are configured for physically penetrating a cellular structure of the at least one microorganism coming in a physical contact with the at least one nanostructured surface of the at least one layer of the substrate of the nanostructured product, wherein the deactivating of the at least one microorganism is based on the physically penetrating of the cellular structure of the at least one microorganism.

2. The nanostructured product of claim 1, wherein the at least one layer comprises at least one pore of at least one size, wherein the at least one pore allows entering of the at least one microorganism coming in the physical contact with the at least one nanostructured surface of the at least one layer of the substrate for trapping the at least one microorganism in the at least one pore, wherein the deactivating of the at least one microorganism is based on the trapping of the at least one microorganism in the at least one pore.

3. The nanostructured product of claim 2, wherein the trapping of the at least one microorganism prevents subsequent physical contacting between the at least one microorganism and at least one object coming in a physical contact with the at least one nanostructured surface for preventing transferring of the at least one microorganism to the at least one object.

4. The nanostructured product of claim 2, wherein the at least one pore is created in the at least one layer using at least one pore creating process, wherein the at least one pore creating process is applied to the at least one layer for creating the at least one pore of the at least one size, wherein the at least one layer comprises the at least one pore based on the creating of the at least one pore.

5. The nanostructured product of claim 1, wherein the deactivating of the at least one microorganism prevents transmitting of the at least one microorganism from the at least one nanostructured surface to at least one object coming in a physical contact with the at least one nanostructured surface.

6. The nanostructured product of claim 1, wherein the nanostructured copper protrusions are associated with a protrusion size, wherein the protrusion size of the nanostructured copper protrusions is smaller than a microorganism size of the at least one microorganism, wherein the physically penetrating of the cellular structure of the at least one microorganism is further based on the protrusion size.

7. The nanostructured product of claim 1, wherein the substrate is comprised of at least one substrate metal, wherein the at least one substrate metal is similar to the at least one metal.

8. The nanostructured product of claim 1, wherein the substrate is comprised of at least one substrate metal, wherein the at least one substrate metal is not similar to the at least one metal.

9. The nanostructured product of claim 1, wherein the substrate is comprised of at least one substrate non-metal.

10. The nanostructured product of claim 1, wherein the at least one layer is created on the substrate using at least one layer creating process, wherein the at least one layer creating process is applied on the substrate for creating the at least one layer on the substrate, wherein the substrate comprises the at least one layer based on the creating.

11. The nanostructured product of claim 10, wherein the creating of the at least one layer on the substrate produces the nanostructured copper protrusions on at least one nanostructured surface in at least one protrusion arrangement, wherein the at least one nanostructured surface comprises the nanostructured copper protrusions based on the creating of the at least one layer.

12. The nanostructured product of claim 11, wherein the at least one nanostructured surface is associated with a deactivating ability for the deactivating of the at least one microorganism, wherein the deactivating ability is based on the at least one protrusion arrangement of the nanostructured copper protrusion.

13. The nanostructured product of claim 1, wherein the at least one microorganism comes in the physical contact with the at least one layer of the substrate of the nanostructured product using at least one microorganism carrier, wherein the at least one microorganism carrier performs at least one contacting action on the nanostructured product, wherein the at least one microorganism comes in the physical contact with the at least one layer of the substrate of the nanostructured product based on the at least one contacting action performed on the nanostructured product.

14. A nanostructured product for facilitating deactivating of microorganisms, wherein the nanostructured product comprises a substrate comprising at least one layer, wherein the at least one layer is comprised of at least one of a pure metal of at least one metal, a metal oxide of the at least one metal, and a metal alloy of the at least one metal, wherein the at least one metal comprises copper, wherein the at least one layer comprises at least one nanostructured surface, wherein the at least one nanostructured surface is configured for deactivating at least one microorganism physically contacting the at least one nanostructured surface, wherein the at least one nanostructured surface comprises nanostructured copper protrusions extending away from the at least one nanostructured surface, wherein the nanostructured copper protrusions are configured for physically penetrating a cellular structure of the at least one microorganism coming in a physical contact with the at least one nanostructured surface of the at least one layer of the substrate of the nanostructured product, wherein the deactivating of the at least one microorganism is based on the physically penetrating of the cellular structure of the at least one microorganism, wherein the at least one layer comprises at least one pore of at least one size, wherein the at least one pore allows entering of the at least one microorganism coming in the physical contact with the at least one nanostructured surface of the at least one layer of the substrate for trapping the at least one microorganism in the at least one pore, wherein the deactivating of the at least one microorganism is based on the trapping of the at least one microorganism in the at least one pore.

15. The nanostructured product of claim 14, wherein the trapping of the at least one microorganism prevents subsequent physical contacting between the at least one microorganism and at least one object coming in a physical contact with the at least one nanostructured surface for preventing transferring of the at least one microorganism to the at least one object.

16. The nanostructured product of claim 14, wherein the at least one pore is created in the at least one layer using at least one pore creating process, wherein the at least one pore creating process is applied to the at least one layer for creating the at least one pore of the at least one size, wherein the at least one layer comprises the at least one pore based on the creating of the at least one pore.

17. The nanostructured product of claim 14, wherein the deactivating of the at least one microorganism prevents transmitting of the at least one microorganism from the at least one nanostructured surface to at least one object coming in a physical contact with the at least one nanostructured surface.

18. The nanostructured product of claim 14, wherein the nanostructured copper protrusions are associated with a protrusion size, wherein the protrusion size of the nanostructured copper protrusions is smaller than a microorganism size of the at least one microorganism, wherein the physically penetrating of the cellular structure of the at least one microorganism is further based on the protrusion size.

19. The nanostructured product of claim 14, wherein the at least one layer is created on the substrate using at least one layer creating process, wherein the at least one layer creating process is applied on the substrate for creating the at least one layer on the substrate, wherein the substrate comprises the at least one layer based on the creating.

20. The nanostructured product of claim 14, wherein the at least one microorganism comes in the physical contact with the at least one layer of the substrate of the nanostructured product using at least one microorganism carrier, wherein the at least one microorganism carrier performs at least one contacting action on the nanostructured product, wherein the at least one microorganism comes in the physical contact with the at least one layer of the substrate of the nanostructured product based on the at least one contacting action performed on the nanostructured product.
